(19) United States
(12) Patent Application Publication
(10) Pub. No.: US 2018/0131090 A1
(43) Pub. Date: May 10, 2018

(54) RADIO WAVE SENSOR AND LUMINAIRE

(71) Applicant: PANASONIC INTELLECTUAL PROPERTY MANAGEMENT CO., LTD., Osaka (JP)

(72) Inventors: Takeshi OHNO, Osaka (JP); Atsushi IRIKAWA, Osaka (JP); Kanchi KATANODA, Osaka (JP)

(21) Appl. No.: 15/793,733

(22) Filed: Oct. 25, 2017

(30) Foreign Application Priority Data
Nov. 7, 2016 (JP) 2016-217361

(51) Int. Cl. H01Q 3/44; G01S 13/06; G01S 13/04

(52) U.S. Cl. CPC H01Q 3/44; H01Q 23/00; G01S 13/04; G01S 13/06

(57) ABSTRACT

A radio wave sensor includes a transmitting antenna configured to radiate radio waves, and a housing that is composed of dielectric material and faces the transmitting antenna. The housing has a first protrusion that protrudes from a region facing the transmitting antenna towards the transmitting antenna. The first protrusion has an entrance surface that allows the radio waves from the transmitting antenna to enter. The entrance surface contains a flat surface parallel to a surface of the transmitting antenna, and an inclined surface that inclines relative to the flat surface in a direction apart from the flat surface.

### CROSS REFERENCE TO RELATED APPLICATION

This application claims the benefit and priority of Japanese Patent Application No. 2016-217361, filed on Nov. 7, 2016, the entire contents of which is incorporated herein by reference.

### TECHNICAL FIELD

The disclosure relates generally to radio wave sensors and luminaires and, more particularly, to a radio wave sensor for detecting, e.g., human presence, which has a transmitting antenna configured to radiate radio waves, and a luminaire including the radio wave sensor.

### BACKGROUND ART

In a related high frequency sensor, it has been known to use radio waves as one of wireless media (for example, JP 2007-104027 A (hereinafter referred to as “Document 1”)). The high frequency sensor described in Document 1 includes a transmitting antenna and a receiving antenna that are mounted on a substrate with a space between them, and a dielectric lens disposed forward of the transmitting and receiving antennae so as to cover the transmitting and receiving antennae.

The high frequency sensor described in Document 1 is configured to detect the presence of an object when the receiving antenna receives radio waves (reflected waves) reflected by the object following output from the transmitting antenna.

The high frequency sensor (radio wave sensor) described in Document 1 needs a dedicated dielectric lens in order to control the directivity of the transmitting antenna, which causes an increase in the number of components thereof.

### SUMMARY

The present disclosure has been achieved in view of the above circumstances, and an object thereof is to provide a radio wave sensor and a luminaire, capable of controlling the directivity of a transmitting antenna without increasing the number of components.

A radio wave sensor according to an aspect of the present disclosure includes a transmitting antenna configured to radiate radio waves, and a housing that is composed of dielectric material and faces the transmitting antenna. The housing has a protrusion that protrudes from a region thereof facing the transmitting antenna towards the transmitting antenna. The protrusion has an entrance surface that allows the radio waves from the transmitting antenna to enter. The entrance surface contains a flat surface parallel to a surface of the transmitting antenna, and an inclined surface that inclines relative to the flat surface in a direction apart from the flat surface.

A luminaire according to an aspect of the present disclosure includes the radio wave sensor and a luminaire body that retains the radio wave sensor.

### BRIEF DESCRIPTION OF THE DRAWINGS

The figures depict one or more implementations in accordance with the present teaching, by way of example only, not by way of limitation. In the figures, like reference numerals refer to the same or similar elements where:

FIG. 1 is a schematic diagram showing an installation example of a radio wave sensor and a luminaire, in accordance with an embodiment of the present disclosure;

FIG. 2 is a perspective view of the radio wave sensor and the luminaire;

FIG. 3 is a schematic diagram of the radio wave sensor as seen from the side of an opening of a housing thereof;

FIG. 4A is a sectional view taken along an X1-X1 line in FIG. 3, and FIG. 4B is a sectional view taken along an Y2-Y2 line in FIG. 3;

FIG. 5 is an enlarged view of part of FIG. 4A;

FIG. 6 is an enlarged view of part of FIG. 4B; and

FIG. 7 is a schematic diagram of a radio wave sensor with an embodiment of the present disclosure as seen from the side of an opening of a housing thereof.

### DETAILED DESCRIPTION

Hereinafter, an embodiment of the present disclosure will be explained. Various modifications may be made in the following embodiment as long as the object of the present disclosure can be attained.

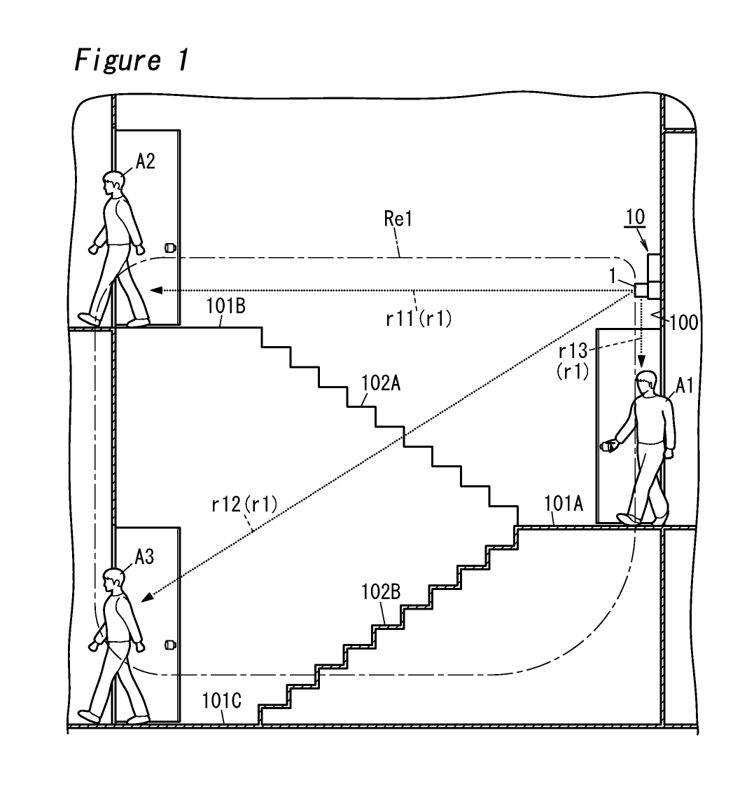

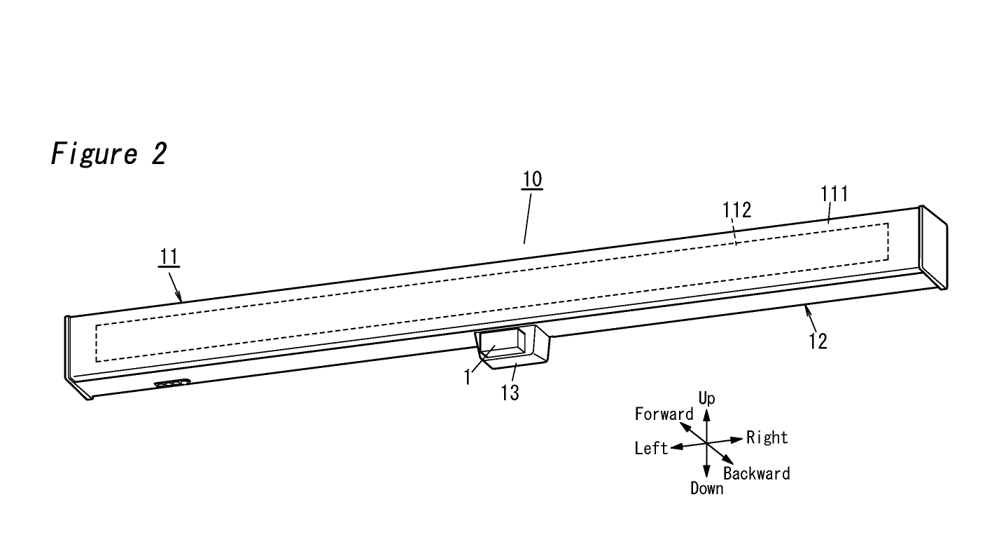

In the example of FIG. 1, a luminaire 10 according to the present embodiment is installed on a wall 100 of a landing 101A between a set of stairs 102A and a set of stairs 102B in a building. The directions of a radio wave sensor 1 and the luminaire 10 are defined by up, down, left, right, forward (fore) and backward (aft) shown by arrows in FIGS. 2 to 6, unless otherwise specifically noted in the explanation below. That is, as seen from the front of the luminaire 10 with the luminaire 10 installed on the wall 100 of the landing 101A, a vertical direction corresponds to the up-and-down direction, a lateral direction corresponds to the left-and-right direction, and a direction normal to the wall 100 corresponds to the fore-and-aft direction. The directions are not intended to limit respective usage types of the radio wave sensor 1 and the luminaire 10. The arrows shown in FIGS. 2 to 6 are merely depicted in order to supplement the description, and do not exist as their respective entities.

Hereinafter, radio waves are also referred to as “radio waves r1” when beams (radio waves in different directions) r11 to r16 of the radio waves are not distinguish from each other.

In the example of FIG. 2, the luminaire 10 includes a light source device 11, a luminaire body 12 and the radio wave sensor 1.

The light source device 11 includes a cover 111 and a light source 112.

For example, the cover 111 has a box shape having an opening in a back surface thereof, and is made from synthetic resin (such as polycarbonate resin or acrylic resin) having translucency. The cover 111 may be elongated in the left-and-right direction.

The light source 112 has, for example a mounting substrate that is flat and elongated in the left-and-right direction. LEDs (Light Emitting Diodes) may be mounted on one surface (front surface) of the mounting substrate at regular intervals along the left-and-right direction (lengthwise direction of mounting substrate).

For example, the cover 111 and the light source 112 are attached to a mounting member, and attached to the luminaire body 12 through the mounting member. The mounting member may be composed of a base plate that is flat and elongated in the left-and-right direction, and two side plates that protrude backward from both ends of the base plate in a width direction thereof (up-and-down direction) so as to have a U shape as seen from the left-and-right direction. For example, the light source 112 is attached on one surface (front surface) of the base plate of the mounting member. The cover 111 is preferably attached to the mounting member to cover the light source 112. A control device 6 and a power supply device may be further attached to the mounting member.

The control device 6 is activated by electric power from a power supply, and configured to turn the light source 112 on and off according to a detection signal (to be described later) from the radio wave sensor 1. For example, when receiving the detection signal from the radio wave sensor 1, the control device 6 provides the power supply device with a control signal that forces the light source 112 to turn on, thereby lighting the light source 112. It is also preferable that when the radio wave sensor 1 stops sending out the detection signal and then a holding time (e.g., several ten seconds) elapses, the control device 6 provide the power supply device with a control signal that forces the light source 112 to turn off or dim, thereby forcing the light source 112 to turn off or dim. Here, “turn on” means that the light source 112 is lit at the light output level of 100%, “turn off” means that the light source 112 is unlit, and “dim” means that the light source 112 is lit at a light output level from more than 0% to less than 100%.

For example, the power supply device is configured to convert AC power from the power supply into DC power to supply the DC power to the light source 112. It is also preferable that the power supply device be configured to increase and decrease the DC power to be supplied to the light source 112 according to a control signal from the control device 6. For example, when receiving the control signal, which forces the light source 112 to turn on, from the control device 6, the power supply device supplies the light source 112 with DC power for turning on the light source 112. In addition, for example, when receiving the control signal, which forces the light source 112 to turn off, from the control device 6, the power supply device stops supplying the DC power to the light source 112.

The luminaire body 12 is, for example, formed by bending a metal plate, and has an elongated box shape having an opening in the front surface thereof. The luminaire body 12 may have a back plate that is flat and elongated in the left-and-right direction, an upper plate and a lower plate that protrude forward from both ends of the back plate in a width direction (widthwise direction) thereof, and a left side-plate and a right side-plate that protrude forward from both ends of the back plate in a lengthwise direction thereof. The back plate of the luminaire body 12 is preferably provided with holes along the left-and-right direction. The luminaire body 12 is fixed on the wall 100 by inserting anchor bolts protruding from, for example the wall 100 of the landing 101A into respective corresponding holes and then tightening nuts on the anchor bolts.

The radio wave sensor 1 is configured to detect the presence (specifically, movement) of an object (person) by transmitting and receiving, for example radio waves in a millimeter wave band as one of wireless media. In the embodiment, the radio wave sensor 1 preferably detects the movement of an object by transmitting and receiving radio waves having the frequency of 24 [GHz]. In the embodiment, examples of the object to be detected with the radio wave sensor 1 include doors provided on the landings 101A, 101B and 101C, and those who open the doors and then enter and exit the landings 101A, 101B and 101C (persons A1, A2 and A3).

Preferably, the radio wave sensor 1 in the present embodiment is a Doppler radio wave sensor that utilizes the Doppler effect, and configured to detect the movement of an object based on the difference between the frequency of radio waves (transmission waves) transmitted from a transmitting antenna 2 to be described later and the frequency of radio waves (reflected waves) received with a receiving antenna 3 to be described later. For example, the radio wave sensor 1 is attached to the center of the lower plate of the luminaire body 12 in the left-and-right direction through a sensor mounting base 13 as shown in FIG. 2. In other words, the luminaire body 12 may be configured to retain the radio wave sensor 1 through the sensor mounting base 13.

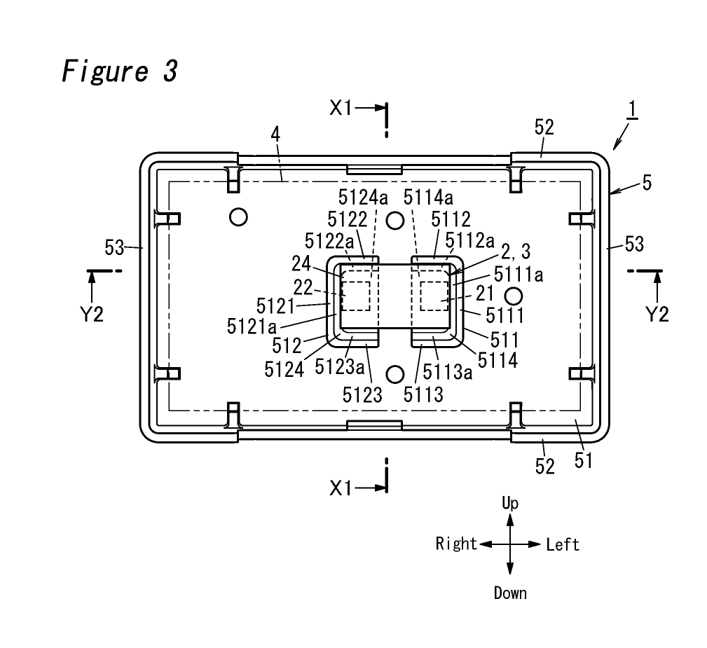

As shown in FIGS. 3 to 6, the radio wave sensor 1 preferably includes the transmitting antenna 2, the receiving antenna 3, a control board 4 and a housing 5.

The radio wave sensor 1 in the present embodiment includes, but not limited to, a transmitting and receiving antenna that constitute the transmitting antenna 2 and the receiving antenna 3. As a specific example, the transmitting and receiving antennae 2 and 3 have a common configuration except for their respective radiation elements 21 and 22. The transmitting antenna 2 is, for example, a microstrip antenna and includes the radiation element 21, a dielectric substrate 23 and a ground conductor 24. The receiving antenna 3 is, for example, a microstrip antenna, and includes the radiation element 22, the dielectric substrate 23 and the ground conductor 24. That is, in the present embodiment, the radiation element 21 as part of the transmitting antenna 2 and the radiation element 22 as part of the receiving antenna 3 are arranged (formed) on the same dielectric substrate 23. The radiation elements 21 and 22 may certainly be arranged on their respective discrete dielectric substrates.

The dielectric substrate 23 is, for example, flat and elongated in the left-and-right direction and is composed of a dielectric (dielectric material) having a relatively low relative dielectric constant such as epoxy resin.

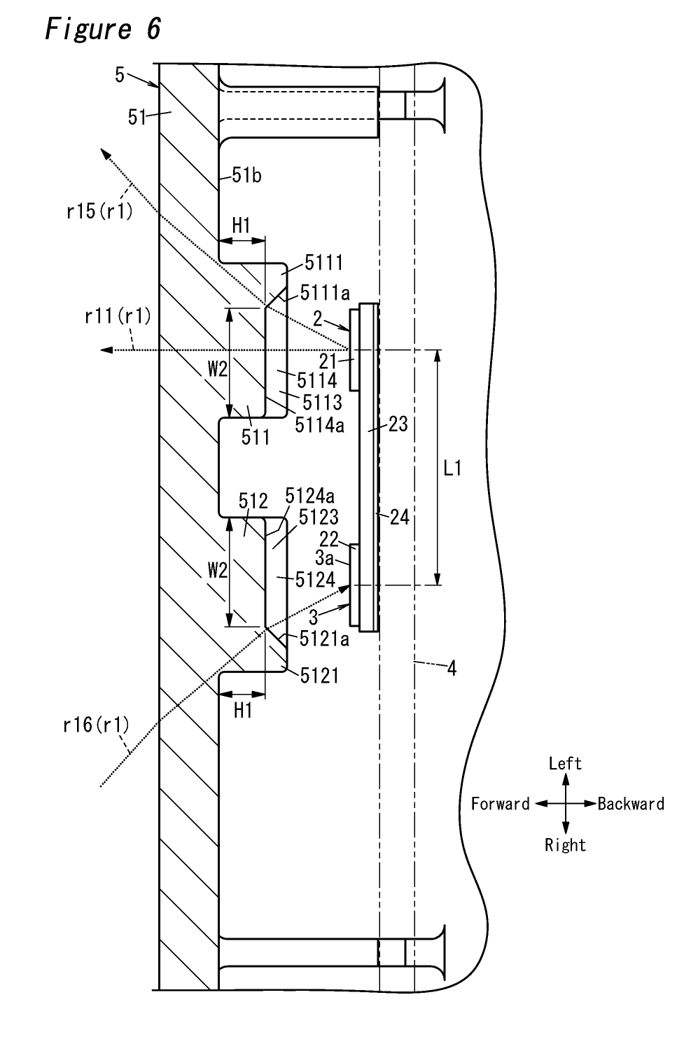

Preferably, the radiation elements 21 and 22 form plus conductors of the transmitting and receiving antennae 2 and 3, and are square in shape and made from electrically conductive material such as copper foil. For example, the radiation elements 21 and 22 are arranged (formed) a distance L1 (see FIG. 6) apart side by side on a first surface (front surface) of the dielectric substrate 23 along a lengthwise direction (left-and-right direction) of the dielectric substrate 23.

Preferably, the ground conductor 24 forms a minus conductor of each of the transmitting and receiving antennae 2 and 3 and is flat and elongated in the left-and-right direction and made from electrically conductive material such as copper foil. For example, the ground conductor 24 has almost the same shape as the dielectric substrate 23, and is arranged (formed) on a second surface (back surface) of the dielectric substrate 23.

The control board 4 preferably has functions as an oscillator configured to provide an oscillation signal to the transmitting antenna 2, and a detector configured to detect the movement of an object based on radio waves r1 received through the receiving antenna 3. The detector may produce a signal (hereinafter referred to as a “mixer output signal”) by mixing (multiplying) the oscillation signal derived from the oscillator and a received signal derived from the receiving antenna 3, and detect the movement of the object based on the mixer output signal. In the present embodiment, since the radio wave sensor 1 is the Doppler radio wave sensor, when a moving object exists in a detection area of the radio wave sensor 1, the frequency of the received signal derived from the receiving antenna 3 shifts by a frequency according to a moving speed of the object from the frequency of the radio waves r1 by the Doppler effect. Thus, when the object is moving, the mixer output signal in the detector is a signal having a frequency that is a difference between the frequency of the radio waves r1 and the frequency of the received signal (i.e., Doppler signal). The detector is preferably configured to compare a signal level of the mixer output signal with a threshold and provide the control device 6 with a signal representing the detection of the movement of the object (detection signal) when the signal level of the mixer output signal exceeds the threshold.

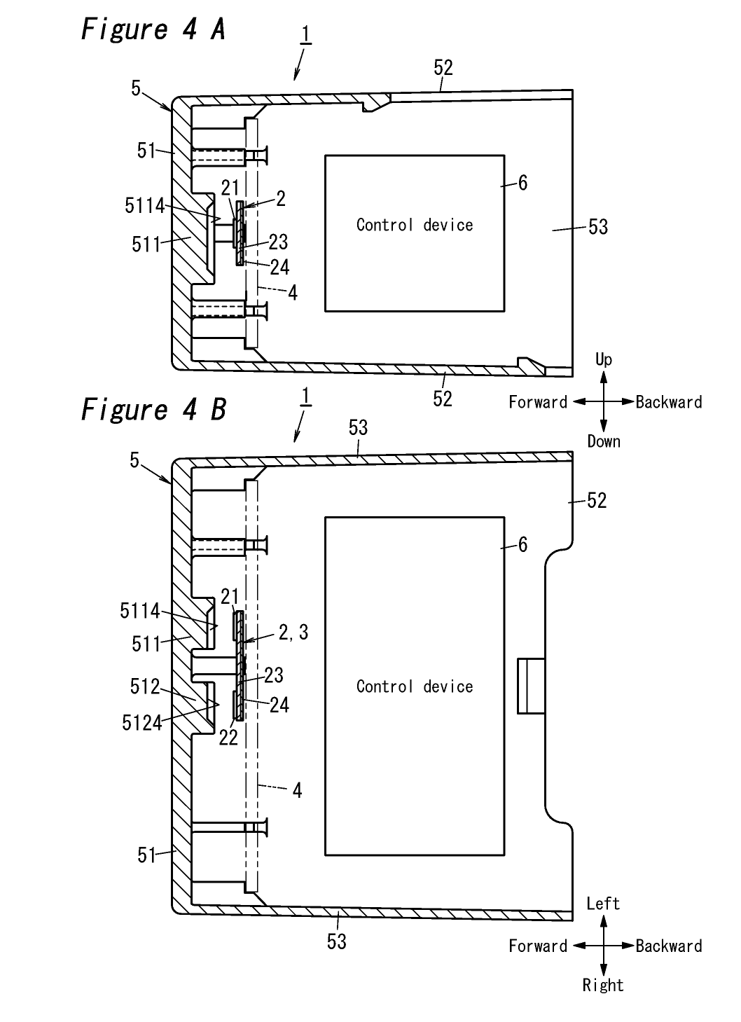

For example, the transmitting and receiving antennae 2 and 3 and the control board 4 are housed in the housing 5 that has a box shape and an opening in a first surface (back surface) thereof as shown in FIGS. 3, 4A and 4B.

The housing 5 is composed of, for example a dielectric having a relatively low relative dielectric constant such as ABS (Acrylonitrile Butadiene Styrene) resin. The housing 5 may have a bottom board 51 that is flat and elongated in the left-and-right direction, two first side boards 52 that protrude backward from both ends of the bottom board 51 in a width direction (widthwise direction) thereof, and two second side boards 53 that protrude backward from both ends of the bottom board 51 in a lengthwise direction thereof.

Preferably, the housing 5 is integrally formed with a first protrusion (protrusion) 511 and a second protrusion 512 that protrude backward from a back surface (facing surface that faces transmitting and receiving antennae 2 and 3) of the bottom board 51. The first and second protrusions 511 and 512 are, for example, rectangular in a plan view and elongated in the up-and-down direction (see FIG. 3). The first protrusion 511 preferably faces the radiation element 21 as part of the transmitting antenna 2 in the fore-and-aft direction with the transmitting and receiving antennae 2 and 3 and the control board 4 housed in the housing 5, as shown in FIGS. 3 to 6. Preferably, the second protrusion 512 also faces the radiation element 22 as part of the receiving antenna 3 in the fore-and-aft direction with the transmitting and receiving antennae 2 and 3 and the control board 4 housed in the housing 5. In the present embodiment, a direction in which the bottom board 51 of the housing 5 faces the transmitting and receiving antennae 2 and 3 corresponds to the fore-and-aft direction.

As shown in FIGS. 3 to 6, preferably, the first protrusion 511 is provided with a recess 5114 in an end of the first protrusion 511, and a bottom face 5114a of the recess 5114 is encompassed by a first protruding wall 5111, a second protruding wall 5112 and a third protruding wall 5113. In the illustrated example, the first, second and third protruding walls 5111, 5112 and 5113 protrude backward from left, upper and lower edges of an end face of the first protrusion 511, respectively. That is, in the present embodiment, the recess 5114 is composed of the first, second and third protruding walls 5111, 5112 and 5113 in addition to the bottom face 5114a.

Preferably, the inside of the recess 5114 in the present embodiment functions as an entrance plane array of the first protrusion (protrusion) 511, and is composed of the bottom face 5114a of the recess 5114, an inner side-face 5111a of the first protruding wall 5111, an inner side-face 5112a of the second protruding wall 5112, and an inner side-face 5113a of the third protruding wall 5113. Preferably, each of the inner side-faces 5111a, 5112a and 5113a in the embodiment inclines relative to the bottom face 5114a in a direction apart from the bottom face 5114a, thereby forming a first inclined surface (inclined surface). In the embodiment, the bottom face 5114a of the recess 5114 is a first flat surface (flat surface). In addition, an inclination angle between the bottom face 5114a and each of the inner side-faces (inclined surfaces) 5111a, 5112a and 5113a is an obtuse angle.

As shown in FIGS. 3 to 6, preferably, the second protrusion 512 is provided with a recess 5124 in an end of the second protrusion 512, and a bottom face 5124a of the recess 5124 is encompassed by a first protruding wall 5121, a second protruding wall 5122 and a third protruding wall 5123. In the illustrated example, the first, second and third protruding walls 5121, 5122 and 5123 protrude backward from right, upper and lower edges of an end face of the second protrusion 512, respectively. That is, in the present embodiment, the recess 5124 is composed of the first, second and third protruding walls 5121, 5122 and 5123 in addition to the bottom face 5124a.

Preferably, the inside of the recess 5124 in the present embodiment functions as a surface array, facing the radiation element 22, of the second protrusion 512, and is composed of the bottom face 5124a of the recess 5124, an inner side-face 5121a of the first protruding wall 5121, an inner side-face 5122a of the second protruding wall 5122, and an inner side-face 5123a of the third protruding wall 5123. Preferably, each of the inner side-faces 5121a, 5122a and 5123a in the embodiment inclines relative to the bottom face 5124a in a direction apart from the bottom face 5124a, thereby forming a second inclined surface. In the embodiment, the bottom face 5124a of the recess 5124 is a second flat surface.

In the illustrated example, the inner side face 5111a of the first protruding wall 5111 in the first protrusion 511 (first inclined surface on left side) is provided on the opposite side of the second protrusion 512 from the bottom face 5114a (first flat surface) of the recess 5114 (on right side in FIG. 3 (on side shown by arrow of “left”)). The inner side face 5121a of the first protruding wall 5121 in the second protrusion 512 (second inclined surface on right side) is provided on the opposite side of the first protrusion 511 from the bottom face 5124a (second flat surface) of the recess 5124 (on left side in FIG. 3 (on side shown by arrow of “right”)). That is, in the example of FIG. 6, the first and second inclined surfaces 5111a and 5121a located forward of the transmitting and receiving antennae 2 and 3 are provided outside the transmitting and receiving antennae 2 and 3 in the left-and-right direction.

In the example of FIG. 6, when the transmitting antenna 2 radiates radio waves r1, beams r11, r15 and the like of the radio waves r1 pass through the bottom board 51 of the housing 5. In this case, the beam r15 of the beams r11, r15 and the like, travelling toward the inner side-face 5111a of the first protruding wall 5111 is refracted when passing through the side of the inner side face 5111a (specifically, inner side-face 5111a and outer surface of bottom board 51), and radiates outside. In the example of FIG. 6, the radio waves r1 (beam r16) that is refracted, when passing through the side of the inner side face 5121a of the first protruding wall 5121 (specifically, outer surface of bottom board 51 and inner side face 5121a), and then enters the receiving antenna 3 is the incoming radio waves from an outside.

Thus, providing the first and second protrusions 511 and 512 facing the transmitting and receiving antennae 2 and 3 with the first and second inclined surfaces (inner side faces 5111a and 5121a), respectively enables expanding the directivity of the transmitting antenna2 outward. It is accordingly possible to weaken the electric field coupling between the transmitting and receiving antennae 2 and 3, thereby suppressing the occurrence of object detection error.

Here, an inclination angle of the inner side face 5111a of the first protruding wall 5111 in the first protrusion 511 is determined by, for example a lateral dimension W2 of the bottom face 5114a of the recess 5114 (see FIG. 6). An inclination angle of the inner side face 5121a of the first protruding wall 5121 in the second protrusion 512 is also determined by, for example a lateral dimension W2 of the bottom face 5124a of the recess 5124 (see FIG. 6). In other words, changing the respective lateral dimensions W2 of the bottom faces 5114a and 5124a enables the adjustment of respective directivity of the transmitting and receiving antennae 2 and 3.

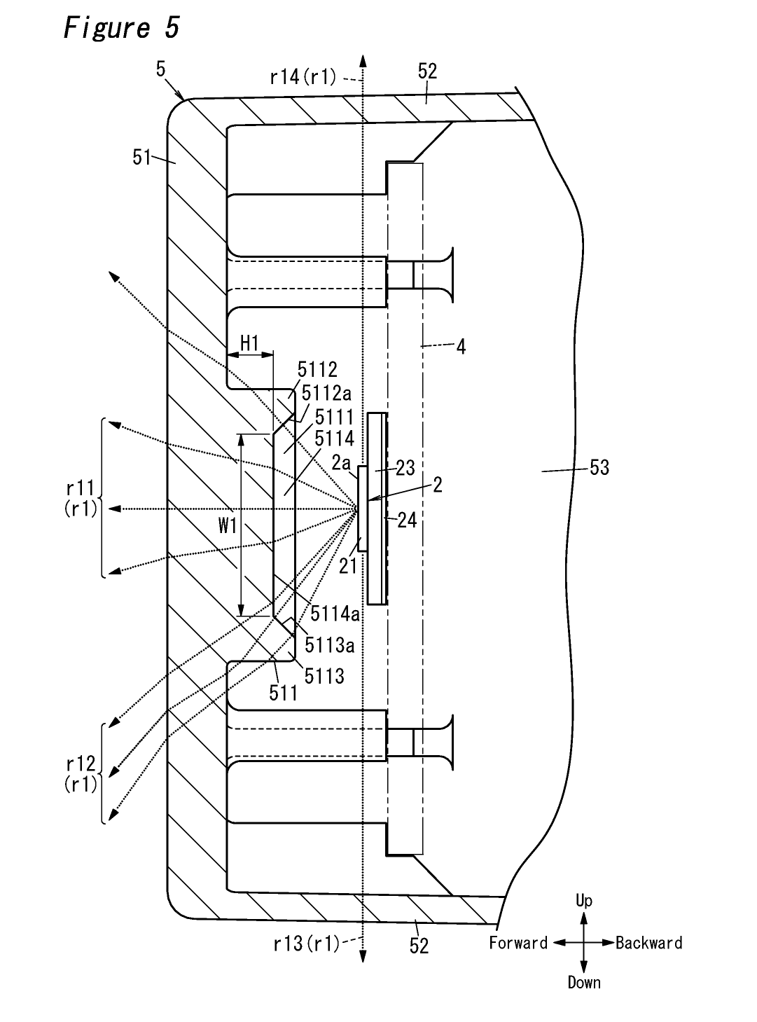

Respective inclination angles of the inner side-faces 5112a and 5113a of the second and third protruding walls 5112 and 5113 in the first protrusion 511 are determined by, for example a vertical dimension W1 of the bottom face 5114a in the recess 5114 (see FIG. 5). Respective inclination angles of the inner side faces 5122a and 5123a of the second and third protruding walls 5122 and 5123 in the second protrusion 512 are also determined by, for example a vertical dimension (not shown) of the bottom face 5124a in the recess 5124. In other words, changing the respective vertical dimensions of the bottom faces 5114a and 5124a enables the adjustment of respective directivity of the transmitting and receiving antennae 2 and 3.

Note that respective protrusion distances H1 of the first and second protrusions 511 and 512 are preferably greater than or equal to a quarter of A1 and less than A1, where A1 is a wavelength of radio waves r1 in the housing 5. In the present embodiment, the respective protrusion distances H1 of the first and second protrusions 511 and 512 are heights from an inner surface 51b of the bottom board 51 in the housing 5 to the bottom faces (flat surfaces) 5114a and 5124a of the recesses 5114 and 5124 in the direction in which the bottom board 51 of the housing 5 faces the transmitting and receiving antennae 2 and 3.

The wavelength λ1 of the radio waves r1 is given by Expression 1 below:

$$λ1 = \frac{c 1}{f 1 \times \sqrt{ɛ 1}} ,$$

where f1 is a frequency of the radio waves r1, c1 is a speed of the radio waves r1, and ε1 is a relative dielectric constant of ABS resin for forming the housing 5.

In the embodiment, preferably, the speed c1 of the radio waves r1 is 3×10⁸ [m/s] and the frequency f1 of the radio waves r1 is 24 [GHz], and therefore the wavelength λ1 of the radio waves r1 is about 7 [mm] when the relative dielectric constant ε1 of the ABS resin is 3.

It is therefore preferable that each of the protrusion distances H1 of the first and second protrusions 511 and 512 be greater than or equal to 1.75 (=λ¼) [mm] and less than 7 [mm]. More preferably, each of the protrusion distances H1 of the first and second protrusions 511 and 512 is about 4.0+/−0.5 [mm].

Adjusting the respective protrusion distances H1 of the first and second protrusions 511 and 512 in the abovementioned range enables strengthening the electric field coupling between the first protrusion 511 and the transmitting antenna 2 as well as the electric field coupling between the second protrusion 512 and the receiving antenna 3 as compared with cases where the distances H1 are not adjusted in the range. It is accordingly possible to weaken the electric field coupling between the transmitting and receiving antennae 2 and 3, thereby suppressing the occurrence of object detection error as a result of part of the radio waves r1 from the transmitting antenna 2 directly entering the receiving antenna 3.

With conventional luminaires, there are some cases where a radio wave sensor is attached to a luminaire with a detection surface of the radio wave sensor directed diagonally downward so that a detection area thereof covers a person in a lower floor rather than the landing where the luminaire is installed. In this case, the radio wave sensor can detect the person in the lower floor, but the radio wave sensor is inclined and therefore the protrusion distance from the wall increases. On the other hand, directing the detection surface of the radio wave sensor forward to decrease the protrusion distance from the wall may prevent the detection area from covering the person in the lower floor.

With the radio wave sensor 1 according to the present embodiment in contrast, since the first protrusion 511 facing the transmitting antenna 2 is provided with the first inclined surface (inclined surface), the directivity of the transmitting antenna 2 can be extended outward (specifically, diagonally upward, diagonally downward and diagonally leftward). The detection area of the radio wave sensor 1 can accordingly cover a person in the lower floor even when the surface of the bottom board 51 in the housing 5 is directed forward. Hereinafter, the directivity of the radio wave sensor 1 will be explained in detail with reference to FIGS. 1 and 5.

FIG. 5 is a schematic diagram showing the radiation of radio waves r1 in a first direction (up-and-down direction).

When the transmitting antenna 2 radiates radio waves r1, beams r11 directed forward (towards front) of beams of the radio waves r1 enter the bottom face (first flat surface) 5114a of the recess 5114 in the first protrusion 511. At this moment, the beam r11 perpendicular to the bottom face 5114a passes through the first protrusion 511 and the bottom board 51 without being refracted and radiate outside. Beams r11 having inclination angles relative to the bottom face 5114a are refracted when passing through the bottom face 5114a, and also refracted when passing through the bottom board 51 after passing through the first protrusion 511, and then radiate outside.

The beam r14 directed vertically upward of the beams of the radio waves r1 passes through one of the first side boards 52 (on upper side in FIG. 5) in the housing 5 without being refracted and then radiates outside. The beam r13 directed vertically downward of the beams of the radio waves r1 passes through the other of the first side boards 52 (on lower side in FIG. 5) of the housing 5 without being refracted and then radiates outside.

Beams r12 directed towards the inner side-face 5113a of the third protruding wall 5113 in the first protrusion 511 of the beams of the radio waves r1 pass through the first protrusion 511 and the bottom board 51, and then radiate outside. At this moment, the beam r12 perpendicular to the inner side-face 5113a travels in the air after passing through the first protrusion 511, and is therefore refracted when entering the air from the first protrusion 511 and when entering the bottom board 51 from the air. Beams r12 having inclination angles relative to the inner side face 5113a are refracted when passing through the inner side face 5113a and travel in the air after passing through the first protrusion 511, and are therefore refracted when entering the air from the first protrusion 511 and when entering the bottom board 51 from the air. The beams r12 entering the bottom board 51 are refracted when passing though the bottom board 51 and then radiate outside.

FIG. 1 is a schematic diagram showing an installation example of the luminaire 10 according to the present embodiment. As stated above, with radio wave sensor 1 according to the present embodiment, the radio waves r1 can be radiated forward, diagonally downward and vertically downward. Therefore, the person A1 on the landing 101A, the person A2 on the landing 101B, and the person A3 on the landing 103A can be detected when the luminaire 10 is installed on the wall 100 of the landing 101A between the set of stairs 102A and the set of stairs 102B in the building as shown in FIG. 1. In the example of FIG. 1, the landing 101B is an upstairs landing above the landing 101A, and the landing 101C is a downstairs landing below the landing 101A. With the radio wave sensor 1 in the present embodiment, the radio wave sensor 1 and the luminaire 10 can be installed with a detection surface of the radio wave sensor 1 directed forward, and therefore the protrusion distance from the wall 100 can be reduced as compared with the conventional luminaires. That is, with the radio wave sensor 1 and the luminaire 10 in the embodiment, the detection area can cover the landings 101A, 101B and 101C without increasing the protrusion distance from the wall 100. Note that Re1 in FIG. 1 shows the detection area of the radio wave sensor 1.

In the example of FIG. 1, as seen from the person A1 on the landing 101A, the set of stairs 102A is provided on the front right side, while the set of stairs 102B is provided on the front left side. It is therefore preferable that the directivity of the radio wave sensor 1 be expanded outward even in the left-and-right direction. Hereinafter, the directivity of the radio wave sensor 1 will be explained in detail with reference to FIG. 6.

FIG. 6 is a schematic diagram showing radio waves r1 in a second direction (left-and-right direction).

When the transmitting antenna 2 radiates radio waves r1, beams r11 directed forward of beams of the radio waves r1 enter the bottom face 5114a of the recess 5114 in the first protrusion 511. At this moment, the beam r11 perpendicular to the bottom face 5114a passes through the first protrusion 511 and the bottom board 51 without being refracted and then radiates outside. Beams r11 having inclination angles relative to the bottom face 5114a are refracted when passing through the bottom face 5114a, and also refracted when passing through the bottom board 51 after passing through the first protrusion 511 and radiate outside.

Beams r15 directed towards the inner side-face 5111a of the first protruding wall 5111 in the first protrusion 511 of the beams of the radio waves r1 pass through the first protrusion 511 and the bottom board 51 and then radiate outside. At this moment, beam r15 perpendicular to the inner side face 5111a passes through the first protrusion 511 without being refracted, and is refracted when passing through the bottom board 51, and then radiates outside. Beams r15 having inclination angles relative to the inner side face 5111a are refracted when passing through the inner side face 5111a, and are refracted when passing through the bottom board 51 after passing through the first protrusion 511 and then radiate outside.

As stated above, with the radio wave sensor 1 in the present embodiment, since the directivity of the radio wave sensor 1 is expanded outward even in the second direction (left-and-right direction), the detection area can cover the set of stairs 102A on the front right side and the set of stairs 102B on the front left side.

The radio wave sensor (high frequency sensor) described in Document 1 controls the directivity with the dedicated dielectric lens. The radio wave sensor 1 of the embodiment in contrast controls the directivity by providing the housing 5 that accommodates the transmitting and receiving antennae 2 and 3 with the first and second protrusions 511 and 512. That is, the radio wave sensor 1 of the embodiment can control the directivity without a dedicated dielectric lens unlike the radio wave sensor described in Document 1. In other words, the radio wave sensor 1 of the embodiment can control the directivity without increasing the number of components thereof unlike the radio wave sensor described in Document 1.

Hereinafter, a modified example of the present embodiment will be explained.

In the embodiment stated above, the first protrusion 511 facing the transmitting antenna 2 and the second protrusion 512 facing the receiving antenna 3 are provided, but at least the first protrusion 511 may be provided so that the directivity of the transmitting antenna 2 can be changed.

In the abovementioned embodiment, the first inclined surfaces are provided on three sides except the side of the second protrusion 512 of the first protrusion 511, and the second inclined surfaces are provided on three sides except for the side of the first protrusion 511 of the second protrusion 512, but the present embodiment is not limited to this. For example, the second protruding wall 5112 on the upper edge of the first protrusion 511 may be omitted because the beam r14 directed vertically upward and beams directed diagonally upward are unnecessary when the luminaire 10 is attached on the wall 100 of the landing 101A as described in the present embodiment. In other words, it is preferable that the first and second inclined surfaces for changing respective directivity of the transmitting and receiving antennae 2 and 3 be provided at places corresponding to directions of the respective directivity to be expanded.

In the abovementioned embodiment, the protruding walls having their respective inclined surfaces are rectangular in shape, but not limited to this. Example thereof may further include circular and triangular. The protruding walls may have their respective shapes corresponding to the whole shape of the antennae (transmitting and receiving antennae 2 and 3).

In the abovementioned embodiment, the bottom board 51 is integrally formed with the first and second protrusions 511 and 512, but may be individually provided with the first and second protrusions 511 and 512. Note that each of the first and second protrusions 511 and 512 needs to be composed of a dielectric.

In the example of the abovementioned embodiment, the protrusion distance of the first protrusion 511 equals the protrusion distance of the second protrusion 512, but may differ from the protrusion distance of the second protrusion 512.

In the example of the abovementioned embodiment, the dielectric forming the housing 5 is made of ABS resin, but no limited to this. The dielectric may be made of different synthetic resin or material other than synthetic resin as long as the relative dielectric constant thereof is about 3 like the ABS resin.

In the example of the abovementioned embodiment, the cross-sectional areas of the first and second protrusions 511 and 512 are larger than the cross-sectional areas of the radiation elements 21 and 22 of the transmitting and receiving antennae 2 and 3, respectively, but the present embodiment is not limited to this. For example, the cross-sectional areas of the radiation elements 21 and 22 may be larger than the cross-sectional areas of the first and second protrusions 511 and 512, or may be equal thereto.

The radiation elements 21 and 22 are square in cross section, but not limited to this. Examples thereof may further include circular and polygonal. The first and second protrusions 511 and 512 are rectangular in cross section, but not limited to this. Examples thereof may further include circular and polygonal. In other words, as long as the radiation elements 21 and 22 face the first and second protrusions 511 and 512, respective, cross sections and sizes of the radiation elements 21 and 22 and the first and second protrusions 511 and 512 may be arbitrarily selected.

In the embodiment, the front surface of the bottom board 51 of the housing 5 that accommodates the transmitting and receiving antennae 2 and 3 (opposite surface to transmitting and receiving antennae 2 and 3) is a flat surface, but not limited to this. Examples thereof may further include a curved surface and the like.

As can clearly be seen from the embodiment stated above, a radio wave sensor 1 according to a first aspect includes a transmitting antenna 2 configured to radiate radio waves r1, and a housing 5 that is composed of a dielectric (dielectric material) and faces the transmitting antenna 2. The housing 5 has a protrusion (first protrusion 511) that protrudes from a region thereof facing the transmitting antenna 2 towards the transmitting antenna 2. The protrusion has an entrance surface (inside of recess 5114) that allows the radio waves r1 from the transmitting antenna 2 to (directly) enter. The entrance surface 5114 contains a flat surface (bottom face 5114a) parallel to a surface 2a of the transmitting antenna 2 (see FIG. 5), and (at least) an inclined surface (inner side-face 5111a, 5112a, 5113a) that inclines relative to the flat surface in a direction apart from the flat surface.

With the first aspect, the housing 5 is provided with the first protrusion 511 (protrusion) for controlling the directivity of the transmitting antenna 2. It is accordingly possible to control the directivity of the transmitting antenna 2 without increasing the number of components thereof without a dedicated dielectric lens unlike the related radio wave sensor.

In the radio wave sensor 1 according to the first aspect, as a second aspect, a protrusion distance (H1) of the protrusion 511 from an inner surface (inner bottom) 51b of the bottom board 51 in the housing 5 to the flat surface (bottom face 5114a) in a direction in which the housing 5 faces the transmitting antenna 2 is greater than or equal to a quarter of a wavelength λ1 of the radio waves r1 in the housing 5 (λ¼) and less than the wavelength (one wavelength λ1).

The second aspect can strengthen the electric field coupling between the transmitting antenna 2 and the protrusion as compared with cases where the distances of the protrusion is not adjusted in the range. Note that this configuration is not indispensable for the radio wave sensor 1. As long as the protrusion protrudes from the bottom board 51 of the housing 5, the protrusion distance of the protrusion need not be in the range.

A radio wave sensor 1 according to a first or second aspect, as a third aspect, further includes a receiving antenna 3 configured to receive radio waves r1 (incoming radio waves, e.g., radio waves (reflected by external object) from the transmitting antenna 2). The transmitting and receiving antennae 2 and 3 are arranged in a direction that intersects with a direction in which an inner surface (inner bottom) 51b of the housing 5 faces the transmitting and receiving antennae 2 and 3. In addition to the protrusion 511 as a first protrusion 511 having the flat surface (bottom face 5114a) as a first flat surface and the inclined surface (inner side-face 5111a, 5112a, 5113a) as a first inclined surface, the housing 5 further includes a second protrusion 512 that protrudes from a region facing the receiving antenna 3 towards the receiving antenna 3. The second protrusion 512 has a facing surface (inside of recess 5124) that faces the receiving antenna 3. The facing surface contains a second flat surface (bottom face 5124a) parallel to a surface 3a of the receiving antenna 3 (see Figure v6), and (at least) a second inclined surface (inner side face 5121a, 5122a, 5123a) that inclines relative to the second flat surface in a direction apart from the second flat surface. The first inclined surface (inner side face 5111a) is provided on an opposite side of the first flat surface from the second protrusion 512. The second inclined surface (inner side face 5121a) is provided on an opposite side of the second flat surface from the first protrusion 511.

With the third aspect, respective directivity of the transmitting and receiving antennae 2 and 3 can be adjusted to the directivity expanded outward. It is accordingly possible to suppress the occurrence of object detection error because the electric field coupling between the transmitting and receiving antennae 2 and 3 can be weakened. Note that this configuration is included as an option.

In the radio wave sensor 1 according to the third aspect, as a fourth aspect, the first and second protrusions 511 and 512 are rectangular in shape as seen from the direction in which the inner surface (inner bottom) 51b of the housing 5 faces the transmitting and receiving antennae 2 and 3. The first protrusion 511 is provided with three first inclined surfaces (inner side faces 5111a, 5112a and 5113a) on three ends thereof except for an end thereof on a side of the second protrusion 512 in a direction in which the transmitting and receiving antennae 2 and 3 are arranged. The second protrusion 512 is provided with three second inclined surfaces (inner side faces 5121a, 5122a and 5123a) on three ends thereof except for one end thereof on a side of the first protrusion 511 in the direction in which the transmitting and receiving antennae 2 and 3 are arranged.

With the fourth aspect, respective directivity of the transmitting and receiving antennae 2 and 3 can be adjusted to the directivity expanded outward in three directions.

In a radio wave sensor 1 according to a third or fourth aspect, as a fifth aspect, the first and second protrusions 511 and 512 have their respective protrusion distances that are different from each other.

With the fifth aspect, the transmitting performance and the receiving performance can be adjusted separately.

In a radio wave sensor 1 according to any of the third to fifth aspects, as a sixth aspect, the transmitting and receiving antennae 2 and 3 have their respective radiation elements 21 and 22. Respective cross-sectional areas of the first and second protrusions 511 and 512 in the direction in which the inner surface (inner bottom) 51b of the housing 5 faces the transmitting and receiving antennae 2 and 3 are larger than respective cross-sectional areas of the radiation elements 21 and 22.

With the sixth aspect, both the transmitting performance and the receiving performance can be improved.

A luminaire according to an aspect includes a radio wave sensor 1 according to any of the first to sixth aspects and a luminaire body 12 that retains the radio wave sensor 1.

With the aspect, the directivity of the radio wave sensor 1 (transmitting antenna 2) can be changed with the radio wave sensor 1 in spite of a simple configuration.

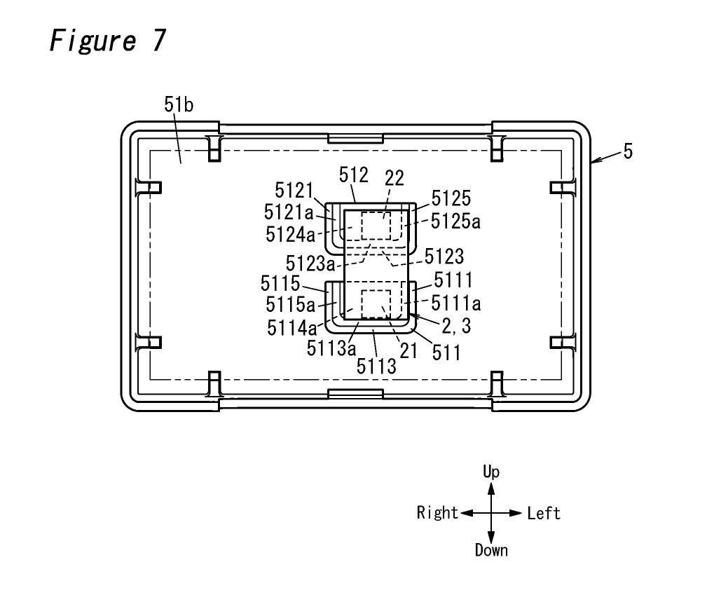

As shown in FIG. 7, a radio wave sensor 1 in accordance with an embodiment of the present disclosure preferably includes a transmitting antenna 2, a receiving antenna 3 and a housing 5. The transmitting antenna 2 includes a flat transmitting element (radiation element 21), and is configured to radiate radio waves r1 from a transmitting surface (see surface 2a in FIG. 5) of the flat transmitting element. The receiving antenna 3 includes a flat receiving element (radiation element 22), and is configured to receive incoming radio waves (e.g., radio waves r1 reflected by an object) onto a receiving surface (see surface 3a in FIG. 6) of the flat receiving surface. The housing 5 is composed of a dielectric. The housing 5 includes a flat front board (bottom board 51) provided forward of the transmitting and receiving surfaces (surfaces 2a and 3a), and accommodates the transmitting and receiving antennae 2 and 3 with the transmitting and receiving surfaces facing an inner surface 51b of the flat front board. The flat front board is provided with a first protrusion 511 and a second protrusion 512 that protrude from respective regions, facing the transmitting surface and the receiving surface, of the inner surface 51b towards the transmitting surface and the receiving surface. The first protrusion 511 includes a first flat surface (bottom face 5114a) parallel to the transmitting surface, and a protruding wall 5113 provided on an opposite end of the first flat surface from the second protrusion 512. The protruding wall 5113 is formed with an inclined surface 5113a that inclines relative to the first flat surface in a direction apart from the first flat surface. The second protrusion 512 includes a second flat surface (bottom face 5124a) parallel to the receiving surface, and a protruding wall 5123 provided on an end of the second flat surface on the side of the first protrusion 511. The protruding wall 5123 is formed with an inclined surface 5123a that inclines relative to the second flat surface in a direction apart from the second flat surface.

In the arrangement of FIG. 1, if the radio wave sensor 1 is installed on the wall 100 with the sides of the protruding walls 5113 and 5123 down, respective directivity of the transmitting and receiving antennae 2 and 3 can be expanded downward. The receiving antenna 3 can also receive the incoming radio waves without increasing the influence of direct radio waves from the transmitting antenna 2.

It is preferable that the first protrusion 511 further include at least one protruding wall 5111, 5115 provided on at least one of both ends of the first flat surface on both sides of the protruding wall 5113, and the protruding wall 5111, 5115 be formed with an inclined surface 5111a, 5115a that inclines relative to the first flat surface in a direction apart from the first flat surface. It is also preferable that the second protrusion 512 further include at least one protruding wall 5121, 5125 provided on at least one of both ends of the second flat surface on both sides of the protruding wall 5123, and the protruding wall 5121, 5125 be formed with an inclined surface 5121a, 5125a that inclines relative to the second flat surface in a direction apart from the second flat surface. In the example of FIG. 7, protruding wall 5111 and 5115 are provided on the both ends of the first flat surface on the both sides of the protruding wall 5113. Protruding wall 5121 and 5125 are also provided on the both ends of the second flat surface on the both sides of the protruding wall 5123. In this example, the respective directivity of the transmitting and receiving antennae 2 and 3 can be expanded leftward and/or rightward.

When the radio wave sensor 1 is provided on the side of the landing 101C unlike the arrangement of FIG. 1, it is preferable that the respective directivity of the transmitting and receiving antennae 2 and 3 be expanded at least upward. In this case, if the radio wave sensor 1 is installed on the wall 100 with the sides of the protruding walls 5113 and 5123 up, the respective directivity of the transmitting and receiving antennae 2 and 3 can be expanded upward. The receiving antenna 3 can also receive the incoming radio waves without increasing the influence of direct radio waves from the transmitting antenna 2.

In the example of FIG. 1, the luminaire 10 is equipped with the radio wave sensor 1, but the radio wave sensor 1 according to the present embodiment is not limited to this. For example, a vehicle may be equipped with the radio wave sensor 1. Specifically, the radio wave sensor 1 may be attached on the vehicle's front side with the sides of the protruding walls 5113 and 5123 down.

While the foregoing has described what are considered to be the best mode and/or other examples, it is understood that various modifications may be made therein and that the subject matter disclosed herein may be implemented in various forms and examples, and that they may be applied in numerous applications, only some of which have been described herein. It is intended by the following claims to claim any and all modifications and variations that fall within the true scope of the present teachings.

1. A radio wave sensor, comprising
a transmitting antenna configured to radiate radio waves, and
a housing that is composed of dielectric material and faces the transmitting antenna, the housing having a protrusion that protrudes from a region thereof facing the transmitting antenna towards the transmitting antenna, the protrusion having an entrance surface that allows the radio waves emitted from the transmitting antenna to enter, the entrance surface containing a flat surface parallel to a surface of the transmitting antenna, and an inclined surface that inclines relative to the flat surface in a direction apart from the flat surface.

2. The radio wave sensor of claim 1, wherein
a protrusion distance of the protrusion from an inner bottom of the housing to the flat surface in a direction in which the inner bottom of the housing faces the transmitting antenna is greater than or equal to a quarter of a wavelength of the radio waves in the housing and less than the wavelength.

3. The radio wave sensor of claim 1, further comprising a receiving antenna configured to receive incoming radio waves, wherein
the transmitting and receiving antennae are arranged in a direction that intersect with a direction in which an inner bottom of the housing faces the transmitting and receiving antennae,
in addition to the protrusion as a first protrusion having the flat surface as a first flat surface and the inclined surface as a first inclined surface, the housing further includes a second protrusion that protrudes from a region facing the receiving antenna towards the receiving antenna,
the second protrusion has a facing surface that faces the receiving antenna, the facing surface containing a second flat surface parallel to a surface of the receiving antenna, and a second inclined surface that inclines relative to the second flat surface in a direction apart from the second flat surface,
the first inclined surface is provided on an opposite side of the first flat surface from the second protrusion, and
the second inclined surface is provided on an opposite side of the second flat surface from the first protrusion.

4. The radio wave sensor of claim 2, further comprising a receiving antenna configured to receive incoming radio waves, wherein
the transmitting and receiving antennae are arranged in a direction that intersect with a direction in which an inner bottom of the housing faces the transmitting and receiving antennae,
in addition to the protrusion as a first protrusion having the flat surface as a first flat surface and the inclined surface as a first inclined surface, the housing further includes a second protrusion that protrudes from a region facing the receiving antenna towards the receiving antenna,
the second protrusion has a facing surface that faces the receiving antenna, the facing surface containing a second flat surface parallel to a surface of the receiving antenna, and a second inclined surface that inclines relative to the second flat surface in a direction apart from the second flat surface,
the first inclined surface is provided on an opposite side of the first flat surface from the second protrusion, and
the second inclined surface is provided on an opposite side of the second flat surface from the first protrusion.

5. The radio wave sensor of claim 3, wherein
the first and second protrusions are rectangular in shape as seen from the direction in which the inner bottom of the housing faces the transmitting and receiving antennae,
the first protrusion is provided with three first inclined surfaces on three ends thereof except for an end thereof on a side of the second protrusion in a direction in which the transmitting and receiving antennae are arranged, and
the second protrusion is provided with three second inclined surfaces on three ends thereof except for one end thereof on a side of the first protrusion in the direction in which the transmitting and receiving antennae are arranged.

6. The radio wave sensor of claim 4, wherein
the first and second protrusions are rectangular in shape as seen from the direction in which the inner bottom of the housing faces the transmitting and receiving antennae,
the first protrusion is provided with first inclined surfaces on three ends thereof except for an end thereof on a side of the second protrusion in a direction in which the transmitting and receiving antennae are arranged, and
the second protrusion is provided with second inclined surfaces on three ends thereof except for one end thereof on a side of the first protrusion in the direction in which the transmitting and receiving antennae are arranged.

7. The radio wave sensor of claim 3, wherein the first and second protrusions have respective protrusion distances that are different from each other.

8. The radio wave sensor of claim 4, wherein the first and second protrusions have respective protrusion distances that are different from each other.

9. The radio wave sensor of claim 3, wherein
the transmitting and receiving antennae have respective radiation elements, and
respective cross-sectional areas of the first and second protrusions in the direction in which the inner bottom of the housing faces the transmitting and receiving antennae are larger than respective cross-sectional areas of the radiation elements.

10. The radio wave sensor of claim 4, wherein
the transmitting and receiving antennae have respective radiation elements, and
respective cross-sectional areas of the first and second protrusions in the direction in which the inner bottom of the housing faces the transmitting and receiving antennae are larger than respective cross-sectional areas of the radiation elements.

11. A radio wave sensor, comprising:
a transmitting antenna that includes a flat transmitting element, and is configured to radiate radio waves from a transmitting surface of the flat transmitting element;
a receiving antenna that includes a flat receiving element, and is configured to receive incoming radio waves onto a receiving surface of the flat receiving element; and
a housing that is composed of dielectric material,
the housing including a flat front board provided forward of the transmitting and receiving surfaces, and accommodating the transmitting and receiving antennae with the transmitting and receiving surfaces facing an inner surface of the flat front board,
the flat front board being provided with a first protrusion and a second protrusion that protrude from respective regions, facing the transmitting surface and the receiving surface, of the inner surface towards the transmitting surface and the receiving surface, respectively,
the first protrusion including a first flat surface parallel to the transmitting surface, and a protruding wall provided on an opposite end of the first flat surface from the second protrusion, the protruding wall of the first protrusion being formed with an inclined surface that inclines relative to the first flat surface in a direction apart from the first flat surface,
the second protrusion including a second flat surface parallel to the receiving surface, and a protruding wall provided on an end of the second flat surface on a side of the first protrusion, the protruding wall of the second protrusion being formed with an inclined surface that inclines relative to the second flat surface in a direction apart from the second flat surface.

12. The radio wave sensor of claim 11, wherein
the first protrusion further includes at least one protruding wall that is provided on at least one of both ends of the first flat surface on both sides of the protruding wall provided on the opposite end of the first flat surface from the second protrusion, and
the at least one protruding wall is formed with an inclined surface that inclines relative to the first flat surface in a direction apart from the first flat surface.

13. The radio wave sensor of claim 11, wherein
the second protrusion further includes at least one protruding wall that is provided on at least one of both ends of the second flat surface on both sides of the protruding wall provided on the end of the second flat surface on the side of the first protrusion, and
the at least one protruding wall is formed with an inclined surface that inclines relative to the second flat surface in a direction apart from the second flat surface.

14. A luminaire, comprising
the radio wave sensor of claim 1, and
a luminaire body that retains the radio wave sensor.

15. A luminaire, comprising
the radio wave sensor of claim 11, and
a luminaire body that retains the radio wave sensor and a control device configured to turn a light source on and off according to a detection signal from the radio wave sensor.
